(19) United States
(12) Patent Application Publication
(10) Pub. No.: US 2016/0259158 A1
(43) Pub. Date: Sep. 8, 2016

(54) POLARIZATION-INDEPENDENT DIFFERENTIAL INTERFERENCE CONTRAST OPTICAL ARRANGEMENT

(71) Applicant: Ramot at Tel-Aviv University Ltd., Tel Aviv (IL)

(72) Inventors: Pinhas GIRSHOVITZ, Beer Sheva (IL); Natan Tzvi SHAKED, Rishon Lezion (IL)

(21) Appl. No.: 15/092,220

(22) Filed: Apr. 6, 2016

Related U.S. Application Data
(63) Continuation-in-part of application No. PCT/IL2014/050885, filed on Oct. 7, 2014.
(60) Provisional application No. 61/887,605, filed on Oct. 7, 2013.

(51) Int. Cl. G02B 21/00; G02B 27/52

(52) U.S. Cl. CPC G02B 21/0056; G02B 27/52

(57) ABSTRACT

The present invention discloses an optical arrangement to be associated with an optical system and an external imaging system, a sample inspection imaging system and a method for generating a differential interference contrast (DIC) image. The optical arrangement comprises a beam-shearing interference module including at least two optical elements being at least partially reflective. A first optical element is configured and operable for receiving an image from the imaging system including an input beam and splitting the input beam into first and second light beams of the same amplitude and phase modulation. A second optical element is accommodated in first and second optical paths of the first and second light beams. At least one of the first and second optical elements is configured and operable for creating a shear between the first and second light beams. The second optical element is configured for reflecting the first and second light beams with a shear between them towards the detector to thereby generate a differential interference contrast (DIC) image.

### TECHNOLOGICAL FIELD

This invention is generally in the field of optical phase contrast imaging, and relates to a system and method for differential interferometric contrast (DIC) measurements used for inspecting samples. The invention can be particularly used with a microscope or other imaging systems to acquire phase profile of transparent, semi-transparent or reflective samples without the need to stain or label them.

### BACKGROUND

Differential interference contrast (DIC) is a microscopy method that is able to obtain contrast in images of transparent samples by passing two orthogonally polarized sheared beams through the sample, and combining them after the sample. By capturing the interference between the two sheared beams, the phase gradient is recorded with a regular camera and transparent objects (such as biological cells in a dish) can be visualized without staining the sample.

In conventional DIC, the light before the sample is polarized using a polarizer, the beams are split using a Nomarski or Wollaston prism into two orthogonal polarized beams (ordinary and extraordinary), and the two sheared beams pass through different but close locations in the sample (typically 0.2-0.4 micron apart). After the sample, the beams are combined by another Nomarski or Wollaston prism and pass through another polarizer. Then, the camera records the interference between the beams, which contains the required image contrast.

However, in known differential interference contrast microscopes, the ordinary and extraordinary light rays are obtained by using the Nomarski prism, which is made of a birefringent crystal, and therefore it is necessary to prepare a plurality of Nomarski prisms which are designed to provide different wavefront shears. It should be noted that since the Nomarski prism is manufactured by precisely processing the birefringent crystal, it is liable to be rather expensive. Therefore, a cost for preparing a plurality of expensive Nomarski prisms becomes very high.

For example, US 2001/010591 discloses a differential interference contrast microscope including an illuminating light source, a polarizer for converting an illumination light ray into a linearly polarized light, a polarized light separating means for dividing the linearly polarized light ray into two linearly polarized light rays having mutually orthogonal vibrating directions, an illuminating optical system, for projecting the two linearly polarized light rays onto an object under inspection, a polarized light combining means for combining the two linearly polarized light rays on a same optical path via an inspecting optical system, an analyzer for forming a differential interference contrast image on an imaging plane. The polarized light separating means is constructed such that an amount of wavefront shear between the two linearly polarized light rays on the object can be changed, and the polarized light combining means is arranged between the object and the analyzer at such a position that the two linearly polarized light rays propagate in parallel with each other and is constructed such that the two linearly polarized light rays can be combined with each other in accordance with the shear amount of wavefront introduced by the polarized light separating means.

One of the problems with conventional DIC is the fact that if the sample itself polarizes the light (for example when imaging cells in a plastic dish), it will not work correctly. Another problem is the system price, since it requires special optical elements inside the microscope that are sometime unique to each microscope objective, and special microscope objectives.

US 2004/017609A discloses a method of differential interference contrast in which the object is illuminated by natural light and the light coming from the object is first polarized after passing through the objective. In this technique, the linearly polarized light is only generated after the sample using only one condenser aperture and prism (for each microscope objective) and one polarizer (less optical elements compared to regular DIC). Since there is no polarizing optics before the sample, this technique is able to image cells grown in plastic dishes. However, this technique still requires special optical elements located inside the microscope and still dependent on the polarization of the sample.

### General Description

The present invention proposes a new technique to implement differential interferometric contrast (DIC) imaging, which does not require special optical elements such as birefringent prisms, and is completely portable and polarization independent. The beams are separated for interference only at the output of the optical system using simple optical elements, which are not sensitive to polarization. The shearing interference, obtained at the output of the optical arrangement/imaging system of the present invention yield DIC images. Therefore, the technique is able to turn an existing transmission microscope, illuminated by conventional white-light source, into a DIC microscope that can image even polarizing samples, such as biological cells in plastic dishes, using a regular microscope objective.

Various configurations of splitting and combining the beams are possible. These include various shearing interferometry setups (see some examples in FIGS. 1-6), where other setups implementing the same principle are possible as well. The common principle in these setups is the fact that the magnified image is taken at the output of the microscope, split into two beams only at the microscope output and combined again, so that there is a small shear between the beams, at the order of less than the diffraction limit (typically 0.2-0.4 microns), multiplied by the total magnification of the microscope, and the resulting image on the detector is very similar to the image obtained by a regular DIC microscope.

The technique provides the ease of use, low cost, portability, and the ability to easily control the DIC shearing parameters, including its direction and the phase off-set.

Therefore, there is provided an optical arrangement to be associated with an optical system and an external imaging system. The optical arrangement comprises a beam-shearing interference module including at least two optical elements being at least partially reflective. A first optical element is configured and operable for receiving an image from the imaging system including an input beam and splitting the input beam into first and second light beams of the same amplitude and phase modulation. A second optical element is accommodated in first and second optical paths of the first and second light beams. At least one of the first and second optical elements is configured and operable for creating a shear between the first and second light beams. The second optical element is configured for reflecting the first and second light beams with a shear between them towards the detector to thereby generate a differential interference contrast (DIC) image. Therefore, the optical arrangement of the present invention is external to the imaging system, does not require polarization elements or prisms, and does not require passing two sheared beams through the sample as in other DIC setups. Thus, it can be made portable to regular imaging systems.

In some embodiments, the second optical element comprises at least two surfaces having a different reflectivity with respect to each other and the first optical element comprises an area between the surfaces having a controllable thickness.

In some embodiments, the shear is created by controlling the position of the at least two optical elements with respect to each other at at least one of a controllable angle and controllable axial location to thereby control shearing and contrast of the DIC image.

In some embodiments, the optical arrangement comprises a third optical element being accommodated in first and second optical paths of the first and second light beams. The shear is created by controlling the positioning of the third optical element with respect to the second optical element.

In some embodiments, at least one of the at least two optical elements comprises at least one retro-reflector, at least one mirror, at least one right-angle prism, at least one phase-conjugate mirror, at least one surface having a certain reflectivity at least one beam splitter unit, and at least one beam splitter/combiner unit.

In some embodiments, at least two optical elements are positioned substantially in parallel with respect to each other.

In some embodiments, the input beam and the first and second light beams are non-polarized.

In some embodiments, the first optical element comprises a beam splitter configured for receiving an input beam and splitting the input beam into the first and second light beams. The beam splitter may be configured for reflecting the first and second light beams, combining reflections of the first and second light beams with a shear between them to produce at least two output combined beams and projecting them towards the detector.

In some embodiments, each of the at least two optical elements is positioned at a substantially equal distance from the beam splitter unit.

In some embodiments, a difference between the distance from the beam splitter unit to each of the at least two optical elements is smaller than a coherence length of the input beam.

In some embodiments, at least one beam splitter/combiner unit comprises a cube beam splitter.

In some embodiments, the beam-shearing interference module comprises one of the following interferometer: a Michelson interferometer, a Mach-Zehnder interferometer and an asymmetric Sagnac interferometer.

In some embodiments, the second optical element comprises at least two optical elements connected between them at their respective proximal ends and forming an angle between them and defining a center axis. The first optical element may comprise a beam splitter. The shear is then defined as an alignment of a splitting plane of the beam splitter unit with the center axis of the second optical element.

In some embodiments, the first and second optical elements comprise a first and second beam splitter, the shear being created by controlling an alignment of splitting planes of the beam splitter units.

According to another broad aspect of the present invention, there is also provided a sample inspection imaging system, comprising: light collecting and focusing optics configured and operable for collecting an input beam from a predetermined sample surface and focusing it onto an image plane; a light source illuminating the sample; an optical arrangement accommodated in a path of the light collected by the light collecting and focusing optics, and being connected at the output of an external imaging system; the optical arrangement as defined above wherein the optical arrangement is configured for receiving an image including an input beam and generating at least two substantially overlapping optical paths towards an optical detector.

In some embodiments, the imaging system comprises a microscope having a certain resolution and defining a microscope image plane.

In some embodiments, the shear between the first and second light beams is less than the resolution of the microscope.

In some embodiments, the system comprises at least two lenses configured and positioned to image the microscope image plane onto the imaging system.

According to another broad aspect of the present invention, there is also provided a method for generating a differential interference contrast (DIC) image. The method comprises: receiving an image including an input beam; splitting the input beam into a first and second light beams of the same amplitude and phase modulation; creating a shear between the first and second light beams being polarization independent; reflecting the first and second light beams with the shear between the beams and combining reflections of the first and second light beams to produce at least two output combined beams to thereby generate a differential interference contrast (DIC) image.

In some embodiments, creating a shear between the first and second light beams comprises positioning at least two optical elements with respect to each other at at least one of a controllable angle and controllable axial location to thereby control shearing and contrast of the DIC image.

In some embodiments, creating a shear between the first and second light beams comprises creating a shear being less than the resolution of a microscope.

### BRIEF DESCRIPTION OF THE DRAWINGS

The patent or application file contains at least one drawing executed in color. Copies of this patent or patent application publication with color drawings will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1a schematically represents an optical arrangement according to some embodiments of the present invention to be associated with an external optical system and detector;

FIGS. 1b-1c schematically represent two possible optical arrangements according to some embodiments of the present invention using two retro-reflectors; in particular, FIG. 1b shows an optical arrangement configured to be positioned before its image plane; FIG. 1c shows an optical arrangement configured to be positioned outside a microscope, where using two lenses to project the image plane of the microscope onto a detector;

FIG. 2 schematically represents another possible optical arrangement configuration according to some embodiments of the present invention in which two lenses are used to image the microscope image plane onto a detector while passing through a Michelson interferometer, where one of the beams is shifted slightly by tilting one of the mirrors;

FIG. 3 schematically represents another possible optical arrangement configuration according to some embodiments of the present invention in which two lenses are used to image the microscope image plane onto a detector while passing through a Mach-Zehnder interferometer, where one of the beams is shifted slightly by tilting one of the mirrors;

FIG. 4 schematically represents another possible optical arrangement configuration according to some embodiments of the present invention in which an asymmetric Sagnac interferometer is used to image the microscope image plane onto a detector while dividing it into two beams and creating a shear between them;

FIG. 5 schematically represents another possible optical arrangement configuration according to some embodiments of the present invention in which an element containing a semi-reflective surface and a fully-reflective surface, located in an angle to create the shear between the two beams is used;

FIG. 6 schematically represents another possible optical arrangement configuration according to some embodiments of the present invention in which two beam-splitter/combiner units are used to create the shear between the two beams; and;

FIGS. 7a-7f show experimental results comparing the optical arrangement of the present invention to a commercially available DIC technique; in particular, FIGS. 7a-7b are images obtained by the optical arrangement shown in FIG. 2; FIGS. 7c-7d are images of the same samples obtained by a commercially available DIC technique; FIGS. 7e-7f are images of the same samples obtained by regular bright field microscopy.

### DETAILED DESCRIPTION OF EMBODIMENTS

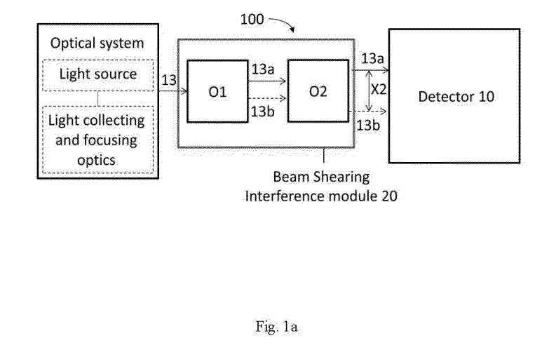

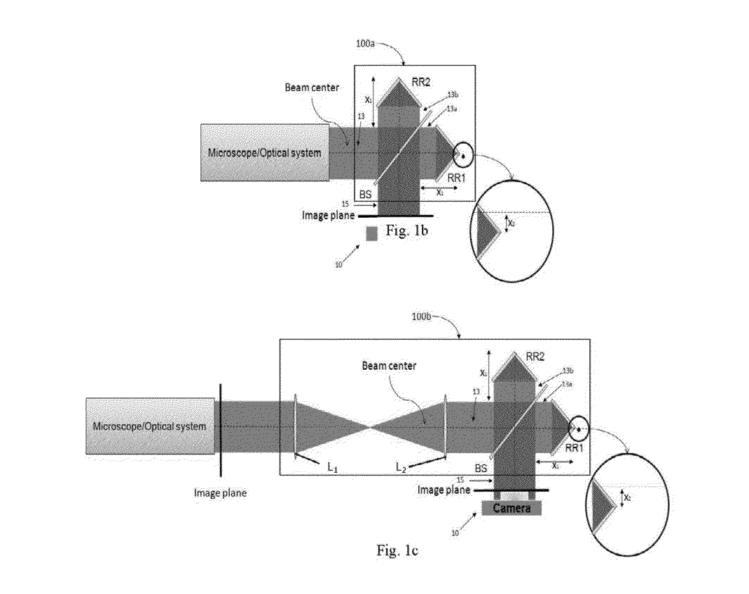

Reference is made to FIG. 1a showing an optical arrangement 100 to be associated with an external optical system/detector 10 and an external imaging system. The optical arrangement 100 comprises a beam-shearing interference module 20 including inter alia a first optical element O1 configured for receiving an image including an input beam from the external imaging system and splitting the input beam into a first and second light beams of the same amplitude and phase modulation 13a and 13b (dashed line); a second optical element O2 being at least partially reflective for receiving the first and second light beams 13a and 13b reflecting the first and second light beams 13a and 13b towards the detector 10 and for creating a shear X2 between the first and second light beams 13a and 13b. The second optical element O2 is accommodated in first and second optical paths of the first and second light beams 13a and 13b. Thus, the first and second light beams are projected onto the detector with a small and fully controllable shear, to optically create a DIC image directly onto the detector, with the ability to image birefringence samples. The two wavefronts are projected on the detector as two separated beams with shearing between the two beams. Although in this configuration, the optical arrangement of the present invention is connected to an external optical system and detector, the optical arrangement of the present invention may be integrated with an optical system and a detector to form a sample inspection and imaging system. As shown by the optional dashed boxes, the optical system may comprise light collecting and focusing optics configured and operable for collecting an input beam from a predetermined sample surface and focusing it onto an image plane; a light source illuminating the sample. If the optical system comprises a microscope, the beam-shearing interference module may be placed inside or outside the microscope depending on the focal length and size of the microscope as will be explained in further details below with respect to FIGS. 1b and 1c.

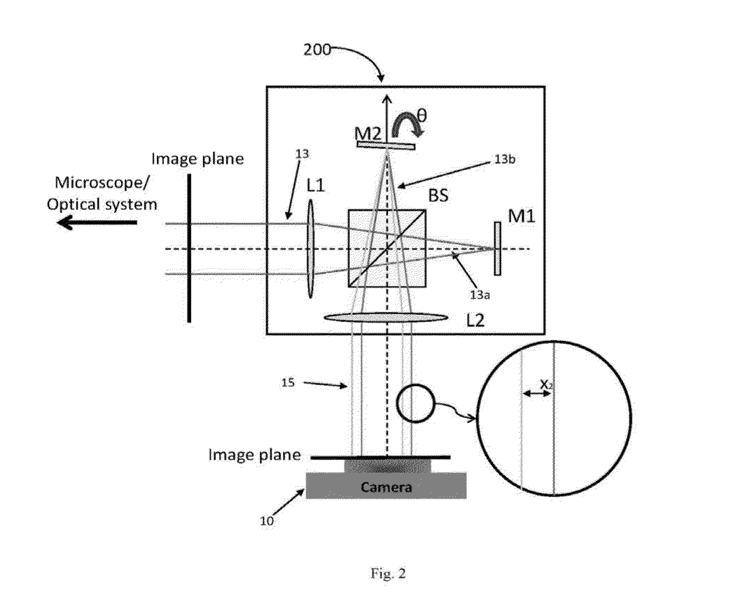

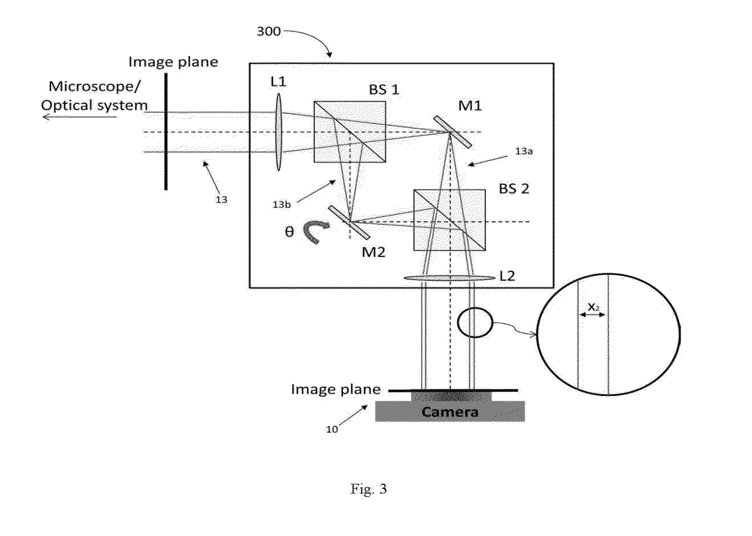

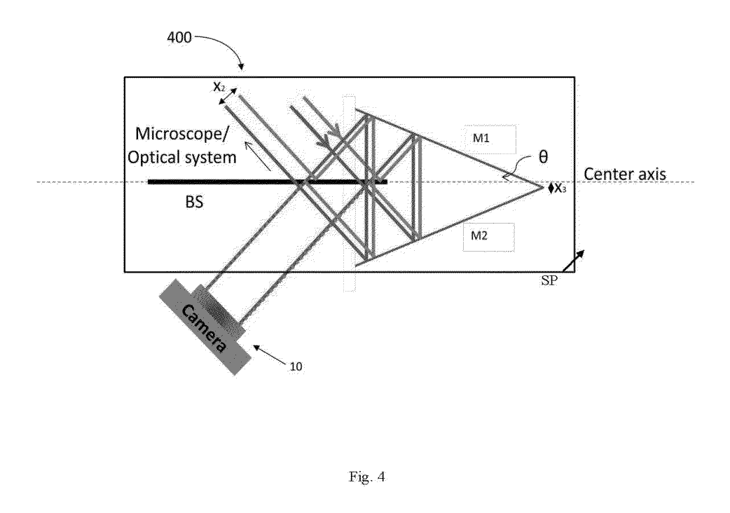

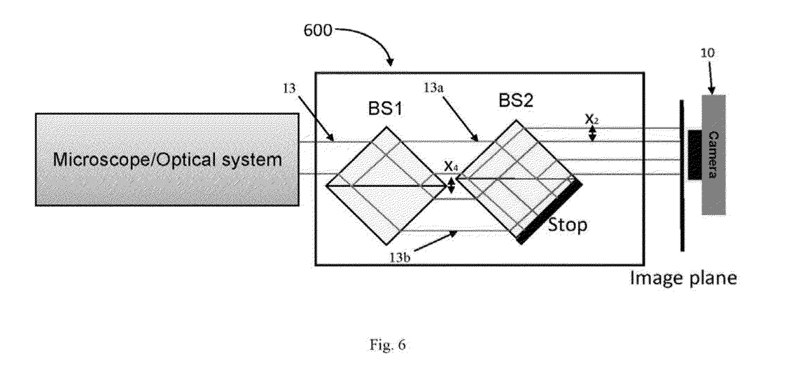

The shear between the first and second light beams 13a and 13b may be created as follows: an axial controllable displacement between the propagation of beams 13a and 13b in element O2 and/or a controllable angle shift between the propagation of beams 13a and 13b in element O2 which create a DIC shear between the beams passing therethrough. The axial displacement may be made in any axial direction as illustrated for example in FIG. 1b. The controllable angle shift is illustrated for example in FIG. 2 and FIG. 3. If one of the two optical elements is a beam splitter/combiner unit, the shear may be provided by creating a controllable angle shift between a splitting plane of the beam splitter/combiner unit and an optical axis of an optical element as illustrated for example in FIG. 4 or in FIG. 6. If the second optical element O2 defines surfaces having a different reflectivity with respect to each other, the shear may also be provided by adjusting a controllable thickness between the surfaces.

The optical arrangement is not affected by the polarization of the input beam or does not use polarization for creating the shear and therefore the input beam (and the split first and second light beams) may be non-polarized.

Reference is made to FIG. 1b showing an optical arrangement 100a which in the present not limiting example is incorporated in an optical system comprising a microscope. The optical arrangement 100a is ported into the microscope output (replacing a digital camera typically installed there in the microscope), before its image plane. This configuration enables to connect a regular camera at the output of the optical arrangement of the present invention. A magnified image of a sample from the microscope is formed by an input beam 13 presenting amplitude and phase modulation of an input light incident on the sample (natural light, non-polarized), the amplitude and phase modulation being indicative of the sample's effect on light passing through. The optical arrangement 100a comprises inter alia a beam shearing interference module comprising a first optical element being in this example a beam splitter/combiner unit BS (being in this specific and non-limiting example a cube beam splitter) configured for receiving an input beam 13 of a certain amplitude and phase modulation indicative of the sample and splitting it into first and second light beams 13a and 13b and directing them onto a second and third optical elements being in this case the retro-reflectors RR1 and RR2 respectively accommodated in the first and second optical paths of the first and second light beams to direct the first and second light beams 13a and 13b back to the beam splitter/combiner unit BS that directs the combined beam to the detector 10. In this embodiment, the optical arrangement 100a comprises a second and a third optical element, wherein the shear is created by controlling the positioning of the third optical element with respect to the second optical element. The retro-reflectors RR1 and RR2 are positioned at the outputs of the beam splitter/combiner unit BS. When a cube beam splitter/combiner unit is used, the retro-reflectors RR1 and RR2 are located in a position so a substantially 90° angle is created between the two optical axis of RR1 and RR2.

It should be noted that the microscope has a certain resolution and defines a microscope image plane. The DIC shear between the first and second light beams provided by the beam-shearing interference module of the present invention may be controlled to be less than the resolution of the microscope.

In some embodiments, each optical element comprises a retro-reflector being a two-mirror construction providing a novel interferometer having an off-axis configuration. Each retro-reflector may comprise a corner reflector, a cat's eye, a right-angle prism used as a retro-reflector or a phase-conjugate mirror. The optical element may also comprise, at least one mirror (shifted or not), at least one right-angle prism, at least one phase-conjugate mirror, at least one surface having a certain reflectivity and at least one beam splitter/combiner unit. For instance, the retro-reflectors RR1 and RR2 may be constructed by a pair of reflecting surfaces. In this non-limiting example, each optical element RR1 and RR2 is positioned at a substantially equal distance from the beam splitter BS noted as x₁. x₁ is selected so the image plane is positioned on the detector 10.

In this specific and non-limiting example, at least one of the retro-reflector introduces a DIC shear noted x₂ between the two beams by changing the position of one retro-reflector in the orthogonal direction respectively to the optical axis of the second retro-reflector. x₂ determines the shearing value between the two wavefronts and it can be controlled by the user to obtain an optimal shearing a contrast. In this specific and non-limiting example, the retro-reflector RR1 is shifted such that an amount of wavefront shear between the light beams can be changed. The retro-reflector creates an amount of spatial separation between the first and second light beams 13a and 13b, called an amount of wavefront shear or a shear amount of wavefront. The displacement of the retro-reflector RR1 changes an amount of wavefront shear between the two light beams 13a and 13b, and the beam splitter/combiner unit BS is arranged between the retro-reflectors RR1 and RR2 at such a position that the first and second light beams 13a and 13b propagate in parallel with each other and are combined with each other on the same optical axis in accordance with a variable amount of wavefront shear introduced by the retro-reflector RR1. The amount of wavefront shear is an important parameter for defining the contrast of the differential interference contrast image and the resolving power of the microscope. In addition, an additional change in the distance of x₁ for at least one of the two retro-reflectors creates an additional contrast effect by changing the value of the illuminated background (destructive interference). Therefore, the optical arrangement provides a beam-shearing interference module in which an illumination beam being indicative of a sample under inspection is sheared into two beams having a spatial separation typically less than the resolution of the microscope. In this manner, an amount of wavefront shear between the two light beams can be changed by using the optical arrangement of the present invention, and thus the construction becomes simple and less expensive.

Reference is made to FIG. 1c showing an optical arrangement 100b configured to be positioned at the output of a microscope when the image plane cannot be placed on the detector due to the size of the arrangement 100a. The optical arrangement 100b comprises inter alia in addition to the elements of the optical arrangement 100a of FIG. 1b, two lenses L₁ and L₂ configured and positioned to image a microscope image plane onto the detector 10.

This principle of portability can be applied to the other configurations shown in FIGS. 4-6 as well.

The beam-shearing interference module of the present invention may comprise one of the following interferometer: a Michelson interferometer as illustrated for example in FIG. 2, a Mach-Zehnder interferometer as illustrated for example in FIG. 3 and an asymmetric Sagnac interferometer as illustrated for example in FIG. 4.

Reference is made to FIG. 2 showing an optical arrangement 200 configured to be positioned at the output of a microscope. The optical arrangement 200 comprises inter alia two lenses L₁ and L₂ configured and positioned to image the microscope image plane onto the detector 10 while passing through a Michelson interferometer formed by a first optical element being in this example a beam splitter/combiner unit BS and a second and third optical elements being in this case two reflecting surfaces M1 and M2. In this embodiment, the optical arrangement 200 comprises a second and a third optical element, wherein the shear is created by controlling the angle of the third optical element with respect to the second optical element. The two lenses L₁ and L₂ forms a Fourier optics assembly configured for applying Fourier transform to an optical field of the input beam 13 and for applying inverse Fourier transform to an optical field of a combined beam 15 propagating from the beam/splitter combiner to the detector. This Fourier optics assembly is thus formed by lenses L₁ and L₂. In this specific and non-limiting example, lens L₁ is located at a distance equals to its focal length from the image plane of the imaging system. Thus, the image plane in the output of the microscope is Fourier transformed by lens L1 and then splits it into first and second beams by a cube beam splitter/combiner BS. The beam splitter/combiner unit BS is configured for receiving an input beam 13 of a certain amplitude and phase modulation indicative of the sample and splitting it into first and second light beams 13a and 13b and directing them onto at least two reflecting surfaces M1 and M2 respectively accommodated in the first and second optical paths of the first and second light beams to direct the first and second light beams 13a and 13b to direct them back to the beam splitter/combiner unit BS that directs the combined beam to the detector 10. The beam 13b is shifted slightly by tilting one of the reflecting surfaces by a certain angle θ respectively to the other reflecting surface. The angle θ creates the DIC shear x₂ shift by shifting the rays.

Reference is made to FIG. 3 showing an optical arrangement 300 configured to be positioned at the output of a microscope. Similarly to the optical arrangement 200 of FIG. 2, two lenses L₁ and L₂ are configured and positioned to image the microscope image plane onto the detector 10 while passing through a Mach-Zehnder interferometer, where one of the beams is shifted slightly by tilting one of the mirrors. The Mach-Zehnder interferometer is formed by first optical element being in this example a beam splitter BS1 and second and third optical elements are in this case the two reflecting surfaces M1 and M2. In this embodiment, the optical arrangement 300 comprises a second and a third optical element, wherein the shear is created by tilting the positioning of the third optical element with respect to the second optical element. The optical arrangement 300 also comprises a second beam splitter BS2 as part of element. An input beam 13 is first split into two parts by the beam splitter BS1 and then recombined by the second beam splitter BS2. Similarly to the configuration of FIG. 2, the beam 13b is shifted slightly by tilting one of the reflecting surfaces by a certain angle θ respectively to the other reflecting surfaces.

Reference is made to FIG. 4 showing an optical arrangement 400 configured to be positioned at the output of a microscope. The optical arrangement 400 comprises a beam-shearing interference module configured as an asymmetric Sagnac interferometer formed by a first optical element being in this example a beam splitter BS and the second optical element being in this case formed by two tilted reflecting surfaces M1 and M2 connecting between them at their respective proximal ends and forming an angle θ. The shear is formed by controlling the alignment between the optical axis of the first and second elements. The splitting plane SP of the beam splitter BS is aligned with a center axis defined by the connection point between the reflecting surfaces M1 and M2. Hence, the axial shear noted as x3 between the SP and the connection point of the two reflecting surfaces M1 and M2 creates the DIC shear. x3 creates the asymmetry in the interferometer that creates the x2 shear between the two beams. In the figure, it is possible to see that two different points from the microscope are recorded by the same pixel on the camera.

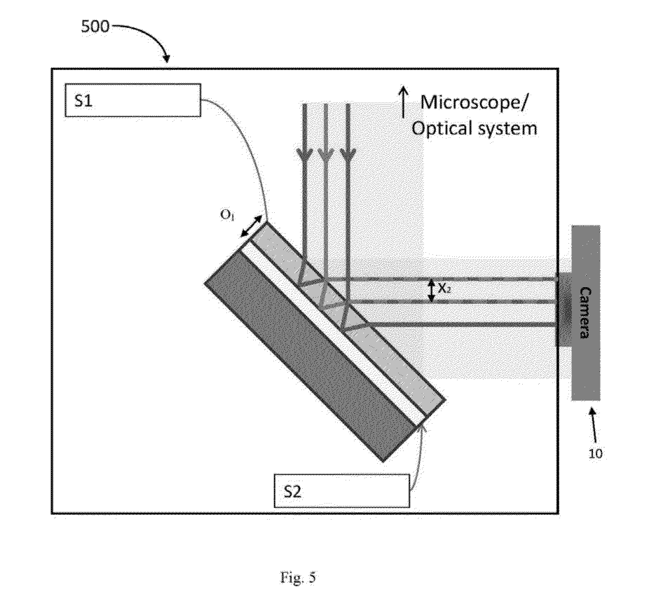

Reference is made to FIG. 5 showing an optical arrangement 500 comprising a beam-shearing interference module including a first element receiving an input beam of a certain amplitude and phase modulation indicative of an image of the sample and splitting the input beam into first and second light beams and directing one beam through surface S1 to the camera 10 and directing the second beam towards surface S2 and then to the camera 10. The camera 10 is accommodated in the first and second optical paths of the first and second light beams. The surfaces S1 and S2 have a different reflectivity with respect to each other, such that a differential interference contrast is created between the first and second light beams propagating therethrough. In this specific and non-limiting example, the thickness of the first element O1 creates the shear between the two beams. As shown in the figure, the DIC shear is formed due to propagation of the beams in the beam-shearing interference module 500. The shear between the beams is created by adjusting the thickness.

Reference is made to FIG. 6 showing an optical arrangement 600 comprising a beam-shearing interference module in which the first and second optical elements and include two beam-splitters BS1 and BS2 respectively being rotated with respect to the direction of the input beam 13 and of the first and second beams 13a and 13b. The first and second beams 13a and 13b comes at an angle of 45° to the surface of the BS1 and BS2. The shear is created by aligning the two beam-splitters BS1 and BS2 with an x₄ shift between their respective splitting planes.

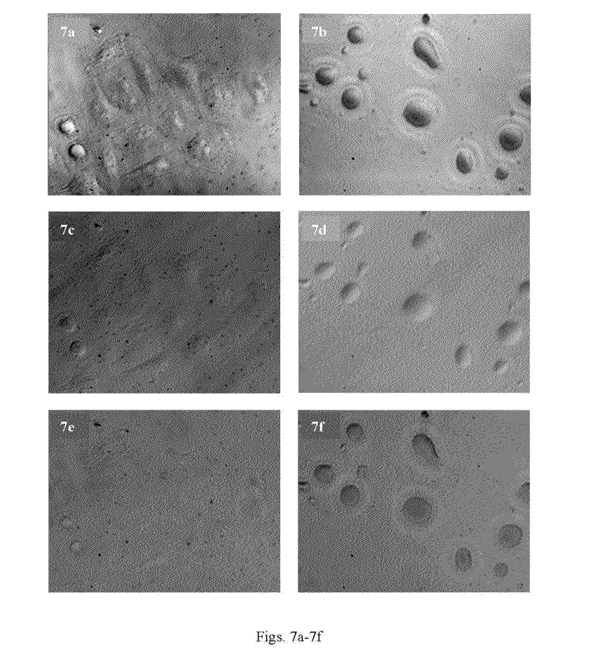

Reference is made to FIGS. 7a-7f showing images obtained by using the teachings of the present invention as compared to a commercially available DIC microscope, integrated with Zeiss' PlasDIC. FIGS. 7a-7b show images obtained by the optical arrangement 200 shown in FIG. 2. FIGS. 7c-7d show images obtained by the commercially available PlasDIC. FIGS. 7e-7f show images of the same samples obtained by regular bright field microscopy when no DIC effect is created and thus a low image contrast is obtained due to the transparency of the sample. FIGS. 7a,7c,7e show images of fixated biological cells (thin sample) and FIGS. 7b,7d,7f show images of water drops (thick sample).

1. An optical arrangement to be associated with an optical system and an imaging system comprising: a beam-shearing interference module comprises at least two optical elements being at least partially reflective, a first optical element being configured and operable for receiving an image from the imaging system including an input beam and splitting said input beam into first and second light beams of the same amplitude and phase modulation and a second optical element being accommodated in first and second optical paths of said first and second light beams; at least one of said first and second optical elements being configured and operable for creating a shear between said first and second light beams; said second optical element being configured for reflecting said first and second light beams with a shear between them towards said detector to thereby generate a differential interference contrast (DIC) image.

2. The optical arrangement of claim 1, wherein said second optical element comprises at least two surfaces having a different reflectivity with respect to each other and said first optical element comprises an area between the surfaces having a controllable thickness.

3. The optical arrangement of claim 1, wherein said shear is created by controlling the position of said at least two optical elements with respect to each other at least one of a controllable angle and controllable axial location to thereby control shearing and contrast of the DIC image.

4. The optical arrangement of claim 1, comprises a third optical element being accommodated in first and second optical paths of said first and second light beams; wherein said shear is created by controlling the positioning of said third optical element with respect to said second optical element.

5. The optical arrangement of claim 1, wherein at least one of said at least two optical elements comprises at least one retro-reflector, at least one mirror, at least one right-angle prism, at least one phase-conjugate mirror, at least one surface having a certain reflectivity at least one beam splitter unit, and at least one beam splitter/combiner unit.

6. The optical arrangement of claim 1, wherein said at least two optical elements are positioned substantially in parallel with respect to each other.

7. The optical arrangement of claim 1, wherein said input beam and said first and second light beams are non-polarized.

8. The optical arrangement of claim 1, wherein said first optical element comprises a beam splitter configured for receiving an input beam and splitting said input beam into said first and second light beams.

9. The optical arrangement of claim 8, wherein said at least one beam splitter is configured for reflecting said first and second light beams, combining reflections of the first and second light beams with a shear between them to produce at least two output combined beams and projecting them towards said detector.

10. The optical arrangement of claim 7, wherein each of said at least two optical elements is positioned at a substantially equal distance from the beam splitter unit.

11. The optical arrangement of claim 10, wherein a difference between the distances from the beam splitter unit to each of said at least two optical elements is smaller than a coherence length of the input beam.

12. The optical arrangement of claim 8, wherein the at least one beam splitter/combiner unit comprises a cube beam splitter.

13. The optical arrangement of claim 1, wherein said beam-shearing interference module comprising one of the following interferometer: a Michelson interferometer, a Mach-Zehnder interferometer and an asymmetric Sagnac interferometer.

14. The optical arrangement of claim 1, wherein said second optical element comprises at least two optical elements connected between them at their respective proximal ends and forming an angle between them and defining a center axis; and said first optical element comprises a beam splitter, said shear being defined as an alignment of a splitting plane of the beam splitter unit with the center axis of the second optical element.

15. The optical arrangement of claim 1, wherein said first and second optical elements comprise a first and second beam splitter, said shear being created by controlling an alignment of splitting planes of the beam splitter units.

16. A sample inspection imaging system, comprising:
light collecting and focusing optics configured and operable for collecting an input beam from a predetermined sample surface and focusing it onto an image plane;
a light source illuminating said sample;
an optical arrangement accommodated in a path of the light collected by the light collecting and focusing optics, and being connected at the output of an external imaging system; the optical arrangement as defined in claim 1, wherein the optical arrangement is configured for receiving an image from the external imaging system and generating at least two substantially overlapping optical paths towards an optical detector.

17. The system of claim 16, wherein said imaging system comprises a microscope having a certain resolution and defining a microscope image plane.

18. The system of claim 17, wherein said shear between said first and second light beams is less than the resolution of the microscope.

19. The system of claim 17, comprising at least two lenses configured and positioned to image the microscope image plane onto the imaging system.

20. A method for generating a differential interference contrast (DIC) image, the method comprises:
receiving an image including an input beam;
splitting said input beam into a first and second light beams of the same amplitude and phase modulation;
creating a shear between said first and second light beams being polarization independent;
reflecting said first and second light beams with the shear between the beams and combining reflections of the first and second light beams to produce at least two output combined beams to thereby generate a differential interference contrast (DIC) image.

21. The method of claim 20, wherein creating a shear between said first and second light beams comprises positioning at least two optical elements with respect to each other at at least one of a controllable angle and controllable axial location to thereby control shearing and contrast of the DIC image.

22. The method of claim 20, wherein creating a shear between said first and second light beams comprises creating a shear being less than the resolution of a microscope.

23. An optical arrangement to be associated with an optical system and an imaging system comprising:
a beam-shearing interference module comprising an arrangement of at least two optical elements being at least partially reflective, wherein
said arrangement of the at least two optical elements is configured and operable for receiving an input unpolarized beam indicative of an image obtained by an optical system characterized by a predetermined diffraction limit, and splitting said input beam into first and second unpolarized light beams of the same amplitude and phase modulation propagating first and second optical paths propagating to a detector of the imaging system;
said arrangement of said at least two optical elements is configured for creating a shear between said first and second light beams at the order of or less than said diffraction limit, thereby producing a differential interference contrast (DIC) image on the detector.
